(19) United States
(12) Patent Application Publication
(10) Pub. No.: US 2025/0142013 A1
(43) Pub. Date: May 1, 2025

(54) METHOD AND APPARATUS FOR GENERATING COLOR MAPPING CARD

(71) Applicant: Beijing Zitiao Network Technology Co., Ltd., Beijing (CN)

(72) Inventor: Yexin ZHENG, Beijing (CN)

(21) Appl. No.: 18/690,643

(22) PCT Filed: Sep. 7, 2022
(86) PCT No.: PCT/CN2022/117558

§ 371 Date: Mar. 8, 2024

(30) Foreign Application Priority Data
Sep. 10, 2021 (CN) 202111062468.X

(51) Int. Cl. H04N 1/60; G06T 7/90; G06V 10/56

(52) U.S. Cl. CPC H04N 1/6005; G06T 7/90; G06V 10/56; G06T 2207/20208

(57) ABSTRACT

The present disclosure provides a method for generating a color mapping card, which includes: transferring colors in a first color set to colors in a second color space of a second color display standard to obtain a second color set; mapping colors in the second color set by an original color mapping card to obtain a third color set; transferring colors in the first color set, the second color set, and the third color set to colors in an HSV color space to obtain a fourth color set, a fifth color set, and a sixth color set corresponding thereto respectively; and performing color mapping on colors in the fourth color set on the basis of colors in the fifth color set and corresponding colors in the sixth color set to generate a color mapping card under the first color display standard.

The present disclosure claims priority to Chinese Patent Application No. 202111062468.X, filed with the China National Intellectual Property Administration on Sep. 10, 2021 and entitled “METHOD AND APPARATUS FOR GENERATING COLOR MAPPING CARD”, which is incorporated herein by reference in its entirety.

### TECHNICAL FIELD

The present disclosure relates to the field of image processing technology, and in particular to a method and an apparatus for generating a color mapping card.

### BACKGROUND

Filter processing is an image processing mode of adjusting color components of an input image, and an output image after processing can present a stylized effect. For example, luminance, contrast, saturation, etc. of the input image may be adjusted through filters.

Essence of filter processing is color mapping. That is, a color of the input image undergoes a series of transferring and mapping, and is output as a new color. The commonly used color mapping mode in the related art is: pre-saving a color mapping relationship in a color mapping card; reading colors of respective pixel points in the input image, when performing color mapping; querying the color mapping card by taking the read colors as index values; and finally, taking the queried colors as colors of corresponding pixel points in the output image. However, color display standards of different images may not be the same; for example, some images have a Standard Dynamic Range (SDR) color display standard, while some images have a High Dynamic Range (HDR) color display standard; and a developer usually only chooses one color display standard to creat a color mapping card. Since color spaces, primary colors, and transfer functions under different color display standards are all different, a color mapping card under one color display standard is only suitable for mapping colors in the color space of the color display standard; if the color mapping card is used to map colors in other color space, output colors will be abnormal. For example, if a color mapping card under the SDR color display standard is used to map colors in a color space of the HDR color display standard, luminance of the output colors will be too low.

In summary, how to use a color mapping card under one color display standard to generate a color mapping card under another color display standard is an urgent problem to be solved.

### SUMMARY

In view of this, embodiments of the present disclosure provide a method and an apparatus for generating a color mapping card, for solving the problem of how to generate a color mapping card under other color display standard by a color mapping card under one color display standard.

To achieve the above objects, embodiments of the present disclosure provide the following technical solutions:

In a first aspect, embodiments of the present disclosure provide a method for generating a color mapping card. The method includes:
transferring colors in a first color set to colors in a second color space of a second color display standard to obtain a second color set, wherein the first color set includes colors in a first color space of a first color display standard;
mapping colors in the second color set by an original color mapping card to obtain a third color set, wherein the original color mapping card is a color mapping card under the second color display standard;
transferring colors in the first color set, the second color set, and the third color set to colors in an HSV color space to obtain a fourth color set, a fifth color set, and a sixth color set corresponding thereto respectively; and
performing color mapping on colors in the fourth color set on the basis of colors in the fifth color set and corresponding colors in the sixth color set to generate a color mapping card under the first color display standard.

In a second aspect, embodiments of the present disclosure provide an apparatus for generating a color mapping card. The apparatus includes:
a first transferring unit, configured to transfer colors in a first color set to colors in a second color space of a second color display standard to obtain a second color set, wherein the first color set includes colors in a first color space of a first color display standard;
a mapping unit, configured to map colors in the second color set by an original color mapping card to obtain a third color set, wherein the original color mapping card is a color mapping card under the second color display standard;
a second transferring unit, configured to transfer colors in the first color set, the second color set, and the third color set to colors in an HSV color space to obtain a fourth color set, a fifth color set, and a sixth color set corresponding thereto respectively; and
a generation unit, configured to perform color mapping on colors in the fourth color set on the basis of colors in the fifth color set and corresponding colors in the sixth color set to generate a color mapping card under the first color display standard.

In a third aspect, embodiments of the present disclosure provide an electronic device. The electronic device includes: a memory and a processor, wherein the memory is configured to store a computer program, the processor is configured to, when executing the computer program, cause the electronic device to implement the method for generating a color mapping card according to any of the above embodiments.

In a fourth aspect, embodiments of the present disclosure provide a computer-readable storage medium. The computer-readable storage medium stores a computer program which, when executed by a computing device, causes the computing device to implement the method for generating a color mapping card according to any of the above embodiments.

In a fifth aspect, embodiments of the present disclosure provide a computer program product, wherein the computer program product, when executed on a computer, causes the computer to implement the method for generating a color mapping card according to any of the above embodiments.

The method for generating a color mapping card according to the embodiments of the present disclosure includes: transferring colors in a first color space of a first color display standard to colors in a second color space of a second color display standard, mapping colors in the transferred second color set by a color mapping card under the second color display standard to obtain a third color set, transferring the colors in the first color space, the second color set, and the third color set to colors in an HSV color space to obtain a fourth color set, a fifth color set, and a sixth color set corresponding thereto respectively, and then performing color mapping on colors in the fourth color set on the basis of colors in the fifth color set and corresponding colors in the six color set to generate a color mapping card under the first color display standard. That is, the embodiments of the present disclosure provide a method for generating a color mapping card, in which the amount of change in an input color and an output color of original map colors can be extracted, the colors in the first color space can be mapped on the basis of the amount of change of the input color and the output color of the original map colors, and finally the color mapping card under the first color display standard is generated. Therefore, the embodiments of the present disclosure provide an implementation of generating the color mapping card under the first color display standard based on the color mapping card under the second color display standard, thus, the problem of how to generate a color mapping card under other color display standard by a color mapping card under one color display standard can be solved. In addition, according to the embodiments of the present disclosure, the developers only need to develop a color mapping card under one color display standard, and can obtain color mapping cards under any other color display standards. Therefore, the disclosed embodiments also greatly simplify the development of color mapping color cards.

### BRIEF DESCRIPTION OF THE DRAWINGS

The accompanying drawings herein are incorporated into the specification and form a part of this specification, illustrating embodiments in accordance with the present disclosure, and are used together with the specification to explain the principles of the disclosed embodiments.

To provide a clearer explanation of the disclosed embodiments or technical solutions in the related art, a brief introduction will be given to the accompanying drawings required in the embodiments or description of the related art. It is obvious that for ordinary technical personnel in the art, other accompanying drawings can be obtained based on these drawings without any creative effort.

FIG. 1 is a schematic diagram of set transfer relationships provided by embodiments of the present disclosure;

FIG. 2 is a flow chart I of steps of a color mapping card generating method provided by embodiments of the present disclosure;

FIG. 3 is a flow chart II of steps of the color mapping card generating method provided by embodiments of the present disclosure;

FIG. 4 is a schematic diagram of a data stream of the color mapping card generating method provided by embodiments of the present disclosure;

FIG. 5 is a structural schematic diagram of a color mapping card generating apparatus provided by embodiments of the present disclosure; and

FIG. 6 is a structural schematic diagram of hardware of an electronic device provided by embodiments of the present disclosure.

### DETAILED DESCRIPTION

To have a clearer understanding of the above objectives, features, and advantages of the disclosed embodiments, the following will further describe the scheme of the disclosed embodiments. It should be noted that in the absence of conflict, the embodiments disclosed herein and the features in the embodiments can be combined with each other.

Specific details are elaborated in the following description to facilitate a full understanding of the disclosed embodiments, but the disclosed embodiments can also be implemented in other ways different from those described here. Obviously, the embodiments in the specification are only a portion of the embodiments of the present disclosure, rather than all of them.

In the embodiments of the present disclosure, words such as “exemplary” or “for example” are used as examples, illustrations, or explanations. Any embodiments or designs described as “exemplary” or “for example” in the present disclosure should not be construed as being more preferred or advantageous than other embodiments or designs. Specifically, the use of words such as “exemplary” or “for example” aims to present relevant concepts in a specific way. In addition, in the description of the present disclosure, unless otherwise specified, the meaning of “multiple” refers to two or more.

A method for generating a color mapping card provided in the embodiments of the present disclosure may be implemented by an apparatus for generating a color mapping card. The apparatus for generating a color mapping card may be a cell phone, a tablet computer, a laptop computer, a palmtop computer, a vehicle-mounted terminal, a wearable device, an ultra-mobile personal computer (UMPC), a netbook, or a personal digital assistant (PDA), a personal computer (PC), a smart home device, and the like, and the embodiments of the present disclosure do not impose specific limitations thereon.

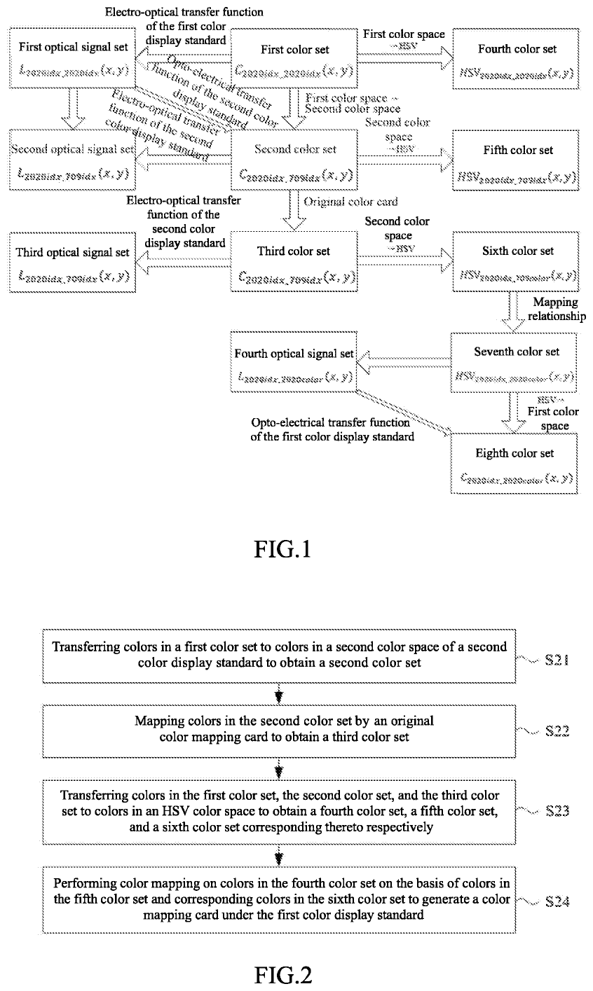

The customized terms as well as transferring relationships between various sets in the embodiments of the present disclosure are first described below with reference to a set transferring relationship diagram shown in FIG. 1:

First color set: A color set of all colors in a first color space of a first color display standard. The embodiments of the present disclosure are illustrated below with the first color display standard being a High Dynamic Range (HDR) color display standard as an example. Since the color space of the HDR color display standard is bt.2020, colors in the first color set are denoted hereinafter by C_{2020idx_2020idx}(x,y). It is to be noted that although the following embodiments are illustrated with the first color display standard being the HDR color display standard as an example, but the embodiments of the present disclosure are not limited thereto; the first color display standard may also be other color display standards, and may be applicable to the technical solutions provided by the embodiments of the present disclosure, as long as the first color display standard and the second color display standard are different color display standards.

Second color set: A color set obtained by transferring the colors in the first color set from the first color space to a color space of a second color display standard. Hereinafter, the embodiments of the present disclosure will be illustrated by taking the second color display standard as a Standard Dynamic Range (SDR) color display standard; since a color space of the SDR color display standard is bt.709, hereinafter, colors in the second color set are represented by C_{2020idx_709idx}(x,y). Similarly, the embodiments of the present disclosure are not limited to the second color display standard being the SDR color display standard; the second color display standard may also be other color display standards, and may be applicable to the technical solutions provided by the embodiments of the present disclosure, as long as the first color display standard and the second color display standard are different color display standards.

Original color mapping card: A color card that supports taking colors in the second color space as an input, and mapping input colors as other colors in the second color space.

Third color set: A color set obtained by mapping the colors in the second color set through the original color mapping card; hereinafter, colors in the third color set are represented by C_{2020idx_709color}(x,y).

Fourth color set: A color set obtained by transferring the colors in the first color set to colors in an HSV color space. Colors in the fourth color set are denoted hereinafter by HSV_{2020idx_2020idx}(x,y).

Fifth color set: A color set obtained by transferring the colors in the second color set to colors in the HSV color space. Colors in the fifth color set are denoted hereinafter by HSV_{2020idx_709idx}(x,y).

Sixth color set: A color set obtained by transferring the colors in the third color set to colors in the HSV color space. Colors in the sixth color set are denoted hereinafter by HSV_{2020idx_709color}(x,y).

Seventh color set: A color set obtained by performing color mapping on the colors in the fourth color set on the basis of the amount of change of each color. Colors in the seventh color set are denoted hereinafter by HSV_{2020idx_2020color}(x,y).

Eighth color set: A color set obtained by transforming colors in the eighth color set to colors in the first color space. The colors in the eighth color set are denoted hereinafter by C_{2020idx_2020color}(x,y).

First optical signal set: An optical signal set obtained by transferring the colors in the first color set into optical signals on the basis of an electro-optical transfer function of the first color display standard. Optical signals in the first optical signal set are denoted hereinafter by L_{2020idx_2020idx}(x,y).

Second optical signal set: An optical signal set obtained by transferring the colors in the second color set into optical signals on the basis of an electro-optical transfer function of the second color display standard. Optical signals in the second optical signal set are denoted hereinafter by L_{2020idx_709idx}(x,y).

Third optical signal set: An optical signal set obtained by transferring the colors in the third color set into optical signals on the base of an electro-optical transfer function of the second color display standard. Optical signals in the third optical signal set are denoted hereinafter by L_{2020idx_709color}(x,y).

Fourth optical signal set: An optical signal set obtained by transferring the colors in the seventh color set into optical signals on the basis of an electro-optical transfer function of the first color display standard. Optical signals in the fourth optical signal set are denoted hereinafter by L_{2020idx_2020color}(x,y).

First color space: A color space of the first color display standard. When the first color display standard refers to the HDR color display standard, the first color space is bt.2020.

Second color space: A color space of the second color display standard. When the first color display standard refers to the SDR color display standard, the second color space is bt.709.

Based on the above content, embodiments of the present disclosure provide a method for generating a color mapping card. With reference to FIG. 2, the method for generating a color mapping card includes at least Steps S21 to S24 as below:

S21. Transferring colors in a first color set to colors in a second color space of a second color display standard to obtain a second color set.

The first color set includes colors in a first color space of a first color display standard.

In the embodiments of the present disclosure, the first color display standard may refer to a color display standard intended to be used for generating a color mapping card on the basis of a color mapping card of other color display standard, and the second color display standard may refer to a color display standard intended to be used for generating a color mapping card on the basis of a color mapping card of other color display standard. The first color display standard and the second color display standard may be any two color display standards, and the embodiments of the present disclosure do not impose limitations on the first color display standard and the second color display standard.

Illustratively, the first color display standard may be a PQ color display standard, and the second color display standard may be an HDR color display standard.

The following embodiments are illustrated with the second color display standard specifically being the Perceptual Quantizer (PQ) color display standard in the HDR color display standard, but the embodiments of the present disclosure are not limited thereto. For example, the second color display standard in the embodiments of the present disclosure may also be a Hybrid Log Gamma (HLG) color display standard in the HDR color display standard.

The PQ color display standard is one of the High Dynamic Range (HDR) color display standard, and under the PQ color display standard, a color space refers to the color space bt.2020, three primary colors refer to the three primary colors bt.2020, and an opto-electrical transfer function is based on the SMPTE2084 standard. Compared with the PQ color display standard, the SDR color display standard allows the display of a smaller maximum brightness, and under the SDR color display standard, a color space refers to the color space bt.709, three primary colors refer to the three primary colors bt.709, and an opto-electrical transfer function is based on the ITU-RBT.1886 standard.

S22. Map colors in the second color set by an original color mapping card to obtain a third color set.

The original color mapping card is a color mapping card under the second color display standard.

Specifically, the original color mapping card may be a color mapping card created by developers using a tool (e.g., a creation tool for applying effects) of the second color display standard. Since the original color mapping card is the color mapping card under the second color display standard, the original color mapping card may accept as input a color in the second color space under the second color display standard and map the input color to another color in the second color space. The colors in the second color set are all colors in the second color space, so that the colors in the second color set may be separately used as inputs to the original color mapping card, and the colors obtained by mapping the colors in the second color set are combined and served as the third color set. It is to be noted that the colors in the third color set are still colors in the second color space.

S23. Transferring the colors in the first color set, the second color set, and the third color set to colors in an HSV color space to obtain a fourth color set, a fifth color set, and a sixth color set corresponding thereto respectively.

That is, the colors in the first color set are transferred to colors in the HSV color space to obtain the fourth color set, the colors in the second color set are transferred to colors in the HSV color space to obtain the fifth color set, and the colors in the third color set are transferred to colors in the HSV color space to obtain the sixth color set.

The HSV color space is a color space created on the basis of the intuitive properties of colors. Colors in the HSV color space are described with Hue, Saturation, and Value.

As an optional implementation of the embodiments of the present disclosure, the above Step S13 (transferring the colors in the first color set, the second color set, and the third color set to colors in the HSV color space to obtain the fourth color set, the fifth color set, and the sixth color set corresponding thereto respectively) includes:
transferring the colors in the first color set, the second color set, and the third color set into optical signals, respectively;
transferring the optical signals obtained by transferring the colors in the first color set into colors in the HSV color space to obtain the fourth color set;
transferring the optical signals obtained by transferring the colors in the second color set into colors in the HSV color space to obtain the fifth color set; and
transferring the optical signals obtained by transferring the colors in the third color set into colors in the HSV color space to obtain the sixth color set.

It is to be noted that the colors in the first color set belong to the first color space, and the colors in the second color set and the third color set all belong to the second color space, so the above Step S23 includes: transferring the colors in the first color space to the colors in the HSV color space and transferring the colors in the second color space to the colors in the HSV color space. The colors in the fourth color set, the fifth color set, and the sixth color set all belong to the HSV color space.

S24. Performing color mapping on colors in the fourth color set on the basis of colors in the fifth color set and corresponding colors in the sixth color set to generate a color mapping card under the first color display standard.

Specifically, the corresponding relationship of colors in different color sets in the embodiments of the present disclosure refers to that if a color in one color set is obtained on the basis of another color in another color set, there is a corresponding relationship between the two colors. For example, a color C_{2020idx_2020idx}(x₁,y₁) in the first color set is transferred to a color C_{2020idx_709idx}(x₁,y₁) in the second color set, a color C_{2020idx_709idx}(x₁,y₁) in the second color set is mapped to a color C_{2020idx_709color}(x₁,y₁) in the third color set, a color C_{2020idx_2020idx}(x₁,y₁) in the first color set is transferred to a color HVS_{2020idx_2020idx}(x₁,y₁) in the fourth color set, a color C_{2020idx_709idx}(x₁,y₁) in the second color set is transferred to a color HVS_{2020idx_709idx}(x₁,y₁) in the fifth color set, and a color C_{2020idx_709color}(x₁,y₁) in the third color set is transferred to a color HVS_{2020idx_2020idx}(x₁,y₁) in the sixth color set, then there is a corresponding relationship between any two of C_{2020idx_2020idx}(x₁,y₁), C_{2020idx_709idx}(x₁,y₁), C_{2020idx_709color}(x₁,y₁), HVS_{2020idx_2020idx}(x₁,y₁), HVS_{2020idx_709idx}(x₁,y₁), and C_{2020idx_709color}(x₁,y₁).

Optionally, the implementations of the above Step S24 (performing color mapping on colors in the fourth color set on the basis of colors in the fifth color set and corresponding colors in the sixth color set to generate the color mapping card under the first color display standard) may include Step a to Step d as follows:

Step a. Obtaining the amount of change of each color on the basis of each color in the fifth color set and a corresponding color in the sixth color set.

Specifically, the colors in the fifth color set and the sixth color set are the colors in the HSV color space, and the colors in the HSV color space are described by three elements, namely, the hue, saturation, and value, so that the amount of change in hue, the amount of change in saturation, and the amount of change in value of each color may be obtained respectively to describe the amount of change of each color.

Step b. Performing color mapping on the colors in the fourth color set on the basis of the amount of change of each color to obtain a seventh color set.

Specifically, since the color mapping card serves to map two color values of the same color display standard so as to achieve a style transferring, when the amount of change of a color before and after that color is transferred by the original color mapping card is obtained, the obtained amount of change may be applied to colors of the other color display standards, and accordingly mapping colors of the colors of the other color display standards can be obtained.

It is to be noted that since the colors in the fourth color set belong to the HSV color space, colors in the seventh color set obtained after mapping still belong to the HSV color space.

Step c. Transferring colors in the seventh color set to colors in the first color space to obtain an eighth color set.

Since the colors in the seventh color set are colors in the HSV color space, Step c refers to transferring the colors in the seventh color set from the HSV color space to the first color space.

Step d. Generating a color mapping card under the first color display standard on the basis of colors in the eighth color set and a corresponding relationship between colors in the eighth color set and colors in the first color set.

According to the embodiments of the present disclosure, a corresponding map color of the first color display standard may be obtained on the basis of colors of the first color display standard, and thus the color mapping card under the first color display standard may be generated on the basis of the colors (the colors in the first color set) of the first color display standard before mapping and the colors (the colors in the eighth color set) of the first color display standard after mapping.

The method for generating a color mapping card according to embodiments of the present disclosure includes: transferring colors in a first color space of a first color display standard to colors in a second color space of a second color display standard, mapping colors in the transferred second color set by a color mapping card under a second color display standard to obtain a third color set, transferring the colors in the first color space, the second color set, and the third color set to colors in an HSV color space to obtain a fourth color set, a fifth color set, and a sixth color set corresponding thereto respectively, and then performing color mapping on colors in the fourth color set on the basis of colors in the fifth color set and the corresponding colors in the six color set to generate a color mapping card under the first color display standard. That is, the embodiments of the present disclosure provide a method for generating a color mapping card, in which the amount of change in an input color and an output color of original map colors can be extracted, colors in the first color space can be mapped on the basis of the amount of change of the input color and the output color of the original map colors, and finally the color mapping card under the first color display standard is generated. Therefore, the embodiments of the present disclosure provide an implementation of generating the color mapping card under the first color display standard by the color mapping card under the second color display standard, solving the problem of how to generate a color mapping card under one color display standard by a color mapping card under other color display standard. In addition, according to the embodiments of the present disclosure, the developers only need to develop a color mapping card under one color display standard and color mapping cards under any other color display standards can be obtained. Thus, the development of color mapping cards is greatly simplified by the embodiments of the present disclosure.

It is to be noted that compared to directly transferring the colors in the third color set to colors in the first color space and then generating the color mapping card under the first color display standard on the basis of the transferred colors, the embodiments of the present disclosure can avoid the loss of the original color data in step S21 (transferring colors in a first color set to colors in a second color space of a second color display standard to obtain a second color set) as well as avoid the introduction of errors in the process of transferring the colors in the third color set to the colors in the first color space, thereby improving the accuracy of the generated color mapping card under the first color display standard.

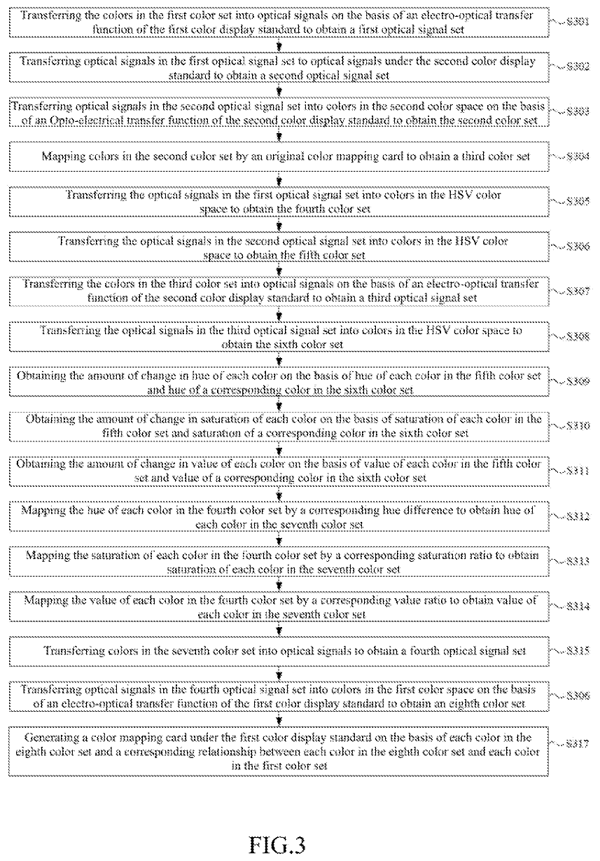

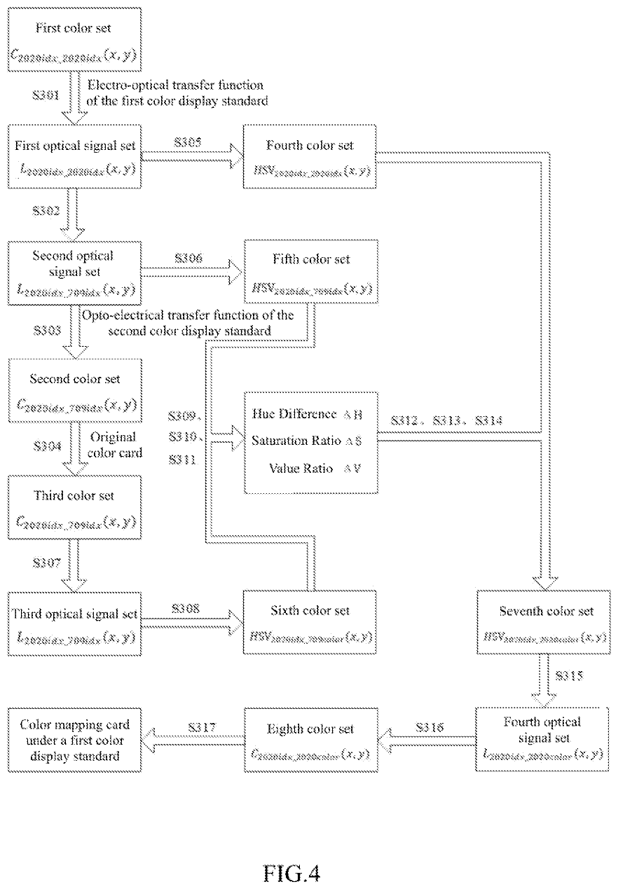

As an extension and detail of the above embodiments, the embodiments of the present disclosure further provide the method for generating a color mapping card. With reference to the flowchart shown in FIG. 3 and the schematic diagram of a data flow shown in FIG. 4, the method for generating the color mapping card includes:

S301. Transferring the colors in the first color set into optical signals on the basis of an electro-optical transfer function of the first color display standard to obtain a first optical signal set.

Specifically, the electro-optical transfer function in the embodiments of the present disclosure refers to a function for describing a relationship between a non-linear color value (digital code pixel value, electrical signal) inputted into a display and a linear color value (optical signal) displayed by the display.

Since a device stores and transmits an electrical signal (color value) and electro-optical transfer functions of different color display standards are different, when transferring a color in the first color space to a color in the second color space, it is first necessary to transfer each color (electrical signal) in the first color space into an optical signal under the first color display standard so as to achieve the transferring of color values of different color spaces in a linear space.

Illustratively, the above Step S301 is illustrated below with the first color display standard being the PQ color display standard and the first color space being bt.2020 as an example.

An opto-electrical transfer function of the PQ color display standard is:

$${L}_{c} = 10000 \times {\{ \frac{max [ ( {V}^{1 / {m}_{2}} - {c}_{1} ) , 0 ]}{{c}_{2} - {c}_{3} {V}^{1 / {m}_{2}}} \}}^{1 / {m}_{1}} \\ \{ \begin{matrix}{m}_{1} = 0.1593017578125 \\ {m}_{2} = 78.84375 \\ {c}_{2} = 18.8515625 \\ {c}_{3} = 18.6875 \\ {c}_{1} = {c}_{3} - {c}_{2} + 1.\end{matrix}$$

where V is an electrical signal under the PQ color display standard, L_{c} is an optical signal under the PQ color display standard, a red component R_{2020idx_2020idx}(x,y), a green component G_{2020idx_2020idx}(x,y), and a blue component B_{2020idx_2020idx}(x,y) of each color C_{2020idx_2020idx}(x,y) in the first color set are respectively substituted into the above formula as the electrical signal V, so that each color in the first color set can be transferred into the optical signal L_{2020idx_2020idx}(x,y) under the PQ color display standard to obtain the first optical signal set.

S302. Transferring optical signals in the first optical signal set to optical signals under the second color display standard to obtain a second optical signal set.

Specifically, the optical signals in the first optical signal set are optical signals under the first color display standard, thus, the optical signals under the first color display standard may be transferred to the optical signals under the second color display standard in the above Step S302. The optical signals under different color display standards have specific transferring matrices, and the optical signals under the first color display standard may be transferred to the optical signals under the second color display standard by the corresponding transferring matrices.

Illustratively, the first color implementation standard is the PQ color display standard and the second standard is the SDR color display standard, a first optical signal under the PQ color display standard is denoted as L_{2020idx_2020idx}(x,y), and a second optical signal under the SDR color display standard that is obtained by transferring L_{2020idx_2020idx}(x,y) is denoted as L_{2020idx_709idx}(x,y). Then,

$${L}_{2020 {idx}_{709 idx}} ( x , y ) = \vert \begin{matrix}1.6605 & - 0.5876 & - 0.0728 \\ - 0.1246 & 1.1329 & - 0.0083 \\ - 0.0182 & - 0.1006 & 1.1187\end{matrix} \vert \times {L}_{2020 {idx}_{2020 idx}} ( x , y ) .$$

In this way, a corresponding optical signal L_{2020idx_709idx}(x,y) under the second color display standard may be obtained by substituting each optical signal in the first optical signal set into the above formula, thus, the second optical signal set is obtained.

S303. Transferring optical signals in the second optical signal set into colors in the second color space on the basis of an opto-electrical transfer function of the second color display standard to obtain the second color set.

The opto-electrical transfer function in the embodiments of the present disclosure refers to a function for describing a relationship between a linear color value (optical signal) and a non-linear color value (digital code pixel value, electrical signal). Each color display standard has a fixed opto-electrical transfer function. When the color display standard to which the optical signal to be subjected to opto-electrical transferring belongs is determined, the transferring of the optical signal to the electrical signal may be realized by the opto-electrical transfer function of the corresponding color display standard. In the embodiments of the present disclosure, the optical signals in the second optical signal set are the optical signals under the second color display standard, and thus the optical signals in the second optical signal set can be transferred into the colors in the second color space by the opto-electrical transfer function of the second color display standard.

As described in the above example, the second color display standard is the SDR color display standard, and an opto-electrical transfer function of the SDR color display standard is:

$$V = \frac{1}{a} [ {max ( {L}_{c} , 0 )}^{\frac{1}{γ}} ] - b \\ a = {( {L}_{ω}^{\frac{1}{γ}} - {L}_{b}^{\frac{1}{γ}} )}^{γ} \\ b = \frac{{L}_{b}^{\frac{1}{γ}}}{{L}_{ω}^{\frac{1}{γ}} - {L}_{b}^{\frac{1}{γ}}}$$

where V is an electrical signal of the second color display standard, L_{c} is an optical signal of the second color display standard, L_{ω} is an optical signal corresponding to a maximum value of the electrical signal, L_{b} is an optical signal corresponding to a minimum value of the electrical signal, and γ is a constant.

Thus, a red optical signal component LR_{2020idx_709idx}(x,y), a green optical signal component LG_{2020idx_709idx}(x,y), and a blue optical signal component LB_{2020idx_709idx}(x,y) of each optical signal L_{2020idx_709idx}(x,y) in the second optical signal set may be substituted into the above opto-electrical transfer function as L_{c}, to obtain a red component R_{2020idx_709idx}(x,y), a green component G_{2020idx_709idx}(x,y), and a blue component B_{2020idx_709idx}(x,y) of each color C_{2020idx_709idx}(x,y) in the second color set, so as to obtain the color C_{2020idx_709idx}(x,y) in the second color set.

Optionally, the optical signal L_{ω} corresponding to the maximum value of the electrical signal and the optical signal L_{b} corresponding to the minimum value of the electrical signal can be normalized. That is, let L_{b}=0, L_{ω}=1, and the optical signals corresponding to the other electrical signals lie between 0 and 1 in floating point form.

So far, by the above Steps S301 to S303, in the embodiments of the present disclosure, the second color set is obtained by transferring the colors in the first color space to colors in the second color space of the second color display standard.

S304. Mapping colors in the second color set by an original color mapping card to obtain a third color set.

The original color mapping card is a color mapping card under the second color display standard.

As an optional implementation of the embodiments of the present disclosure, the original color mapping card includes a color patch corresponding to each color in the second color space. That is, the colors in the second color space correspond to the color patches in the original color mapping card one by one, and each color in the second color space may be uniquely mapped to another color in the color space by the original color mapping card.

When the colors in the second color space correspond to the color patches in the original color mapping card one by one, the above Step S304 (map colors in the second color set by an original color mapping card to obtain a third color set) includes:
searching a corresponding color patch in the original color mapping card with each color in the second color set as an index value, to obtain a map color C_{2020idx_709color}(x,y) of that color in the second color set, and then combining the map colors C_{2020idx_709color}(x,y) of the colors in the second color set to form the third color set.

As an optional implementation of the embodiments of the present disclosure, the original color mapping card includes a plurality of mapping color groups; first color components of the plurality of mapping color groups are a plurality of sampling values of a first color component of the second space, respectively. The above step S304 (map colors in the second color set by an original color mapping card to obtain a third color set) includes Step e to Step i as follows:

Step e. Obtain a first mapping color group and a second mapping color group corresponding to each color on the basis of a first color component of each color in the second color set.

The first mapping color group and the second mapping color group corresponding to a color are mapping color groups with first color components adjacent to the first color component of that color.

The first color component of the mapping color group in the original color mapping card in the embodiments of the present disclosure may refer to: by dividing colors with the same first color component in the second color space into a color group, and grouping the map colors of all the colors in one color group as a mapping color group, the first color component of each color in the color group mapped by that mapping color group is the first color component of the mapping color group. For example, if all the colors in the second color space having a first color component of m are used as a color group, and the map colors of the colors in the color group are used as a mapping color group, then the mapping color group has a first color component of m.

Illustratively, the plurality of sampling values of the first color component are 0, 1/63, 2/63, 3/63, 4/63, . . . 62/63, and 1, and the first color component of a specific color in the second color set is 18/255, then the first color component of the color lies between the sampling value 4/63 and the sampling value 5/63 (map colors adjacent to the first color component of the color include the mapping color groups with the first color components of 4/63 and 5/63, respectively), and thus the map color set with the first color component of 4/63 and the map color set with the first color component of 5/63 are determined to be the first mapping color group and the second mapping color group corresponding to that color, respectively.

Further, when the first color component is a blue component, the original mapping card includes 8*8 mapping color groups; and from left to right and from top to bottom, the blue component of the mapping color group is 0, 1/63, 2/63, 3/63, . . . , 62/63, and 1 sequentially, the starting coordinates of the first mapping color group corresponding to a color C_{(R,G,B)} in the first color set is (x_{floor}, y_{floor}), and the starting coordinates of the second mapping color group corresponding to a color C_{2020idx_2020idx}(x,y) in the first color set is (x_{ceil}, y_{ceil}), then

$${y}_{floor} = ⌊ \frac{B \times 63}{8} ⌋ ; \\ {x}_{floor} = ⌊ B \times 63 ⌋ - {y}_{floor} \times 8 ; \\ {y}_{ceil} = ⌊ \frac{⌈ B \times 63 ⌉}{8} ⌋ ; \\ {x}_{ceil} = ⌈ B \times 63 ⌉ - {y}_{floor} \times 8.$$

Step f. Obtain a first coordinate value and a second coordinate value corresponding to each color in the first mapping color group and the second mapping color group, respectively on the basis of a second color component and a third color component of each color in the second color set.

Illustratively, when the first color component is a blue component, the second color component is a red component, and the third color component is a green component, the original mapping card includes 8*8 mapping color groups and 512*512 color patches; and from left to right and from top to bottom, the blue component of the mapping color groups is 0, 1/63, 2/63, 3/63, . . . , 62/63, and 1 sequentially; and the red component of each color of each map color set increases from 0 to 1 along the x-axis, and the red component of each color of each map color set increases from 0 to 1 along the y-axis; the starting coordinates of the first mapping color group corresponding to a color C_{2020idx_709idx}(x,y) in the second color set are (x_{floor}, y_{floor}), the starting coordinates of the second mapping color group corresponding to a color C_{2020idx_709idx}(x,y) in the second color set are (x_{ceil}, y_{ceil}), a sampling coordinate value (first coordinate value) of the color C_{2020idx_709idx}(x,y) in the second color set in the first mapping color group is (posₓ_{_{floor}}, pos_{y}_{_{floor}}), a sampling coordinate value (second coordinate value) of the color C_{2020idx_709idx}(x,y) in the second color set in the second mapping color group is (posₓ_{_{ceil}}, pos_{y}_{_{ceil}}), then:

$${pos}_{{x}_{floor}} = \frac{{x}_{floor}}{8} + \frac{0.5}{512} + ( \frac{1}{8} - \frac{1}{512} ) \times {R}_{2020 idx \_ 709 idx} ( x , y ) \\ {pos}_{{y}_{floor}} = \frac{{y}_{floor}}{8} + \frac{0.5}{512} + ( \frac{1}{8} - \frac{1}{512} ) \times {G}_{2020 idx \_ 709 idx} ( x , y ) \\ {pos}_{{x}_{ceil}} = \frac{{x}_{ceil}}{8} + \frac{0.5}{512} + ( \frac{1}{8} - \frac{1}{512} ) \times {R}_{2020 idx \_ 709 idx} ( x , y ) \\ {pos}_{{y}_{ceil}} = \frac{{y}_{ceil}}{8} + \frac{0.5}{512} + ( \frac{1}{8} - \frac{1}{512} ) \times {G}_{2020 idx \_ 709 idx} ( x , y )$$

Step g. Read a first map color and a second map color of each color in the original color mapping card on the basis of the first coordinate value and the second coordinate value corresponding to each color in the second color set, respectively.

That is, the color at the first coordinate value corresponding to each color in the original color mapping card (first mapping color group) is read as the first mapping color of each color, and the color at the second coordinate value corresponding to each color in the original color mapping card (second mapping color group) is read as the second mapping color of each color.

Step h. Obtain a map color of each color in the second color set on the basis of the first map color and the second map color of each color in the second color set.

As an optional implementation of the embodiments of the present disclosure, the above Step h (obtain a map color of each color in the second color set on the basis of the first map color and the second map color of each color in the second color set) includes Step 1 and Step 2 as below.

Step 1. Obtain a weighting coefficient for each color in the first color set on the basis of the first color component of each color in the second color set.

Illustratively, when the first color component is a blue component, the original mapping card includes 8*8 mapping color groups; and from left to right and from top to bottom, the blue component of the mapping color group is 0, 1/63, 2/63, 3/63, . . . , 62/63, and 1 sequentially; then that obtaining a weighting coefficients for each color in the second color set on the basis of the blue component of each color of the second color set may include obtaining a weighting coefficients of each color according to the following formula:

$$S = {B}_{2020 idx \_ 709 idx} ( x , y ) \times 63 - ⌊ {B}_{2020 idx \_ 709 idx} ( x , y ) \times 63 ⌋$$

where B_{2020idx_709idx}(x,y) is the blue component of the color C_{2020idx_709idx}(x,y) in the second color set and S is a weighting coefficient of the color C_{2020idx_709idx}(x,y) in the second color set.

Step 2. Applying weights on the first map color and the second map color of each color in the first color set on the basis of the weighting coefficient to obtain a map color of each color in the second color set.

Let: the first map color of the color C_{2020idx_709idx}(x,y) in the second color set be C(posₓ_{_{floor}}, pos_{y}_{_{floor}}), the second map color be C(posₓ_{_{ceil}}, pos_{y}_{_{ceil}}), the map color be C_{2020idx_709color}(x,y) and the weighting coefficient be S. Then:

$${C}_{2020 idx \_ 709 color} ( x , y ) = C ( {pos}_{{x}_{floor}} , {pos}_{{y}_{floor}} ) \times ( 1 - S ) + C ( {pos}_{{x}_{ceil}} , {pos}_{{y}_{ceil}} ) \times S$$

Step i: Generate the third color set on the basis of map colors of colors in the second color set.

When the first color components of the mapping color group are a plurality of sampling values of the first color component of a color under the second color display standard respectively, in some cases, the first color component of the color in the first color set will be between two sampling values, and therefore, if the mapping color group corresponding to one of the sampling values is directly selected for color mapping, it will bring about a large error. In the above embodiments, the first mapping color group and the second mapping color group with first color components adjacent to that of each color are obtained; and on the basis of the second color component and the third color component, the first coordinate value and the second coordinate value corresponding to each color are obtained in the first mapping color group and in the second mapping color group, respectively; the first map color and the second map color of each color are read from the original color mapping card on the basis of the first coordinate value and the second coordinate value corresponding to each color in the second color set, respectively; and finally, the map color of each color is obtained on the basis of the first map color and the second map color of that color. In the above embodiments, the map colors may be obtained in two adjacent mapping color groups respectively, and the final map colors may be obtained on the basis of the map colors obtained in the two mapping color groups jointly, and accordingly, the above embodiments can reduce the error in color mapping, and improve the accuracy of the generated color mapping card.

Up to this point, by the above Steps S301 to S304, in the embodiments of the present disclosure, each color in the first color set is mapped to a corresponding map color in the second color space by the original color mapping card under the second color display standard.

Returning to FIG. 3, the method for generating a color mapping card according to the embodiments of the present disclosure may further include:

S305: Transferring the optical signals in the first optical signal set into colors in HSV color space to obtain the fourth color set.

The first optical signal set is an optical signal set generated in the above Step S301.

The transferring between the optical signal and the color in the HSV color space follows the following equations:

$$H = \{ \begin{matrix}0 & Δ = 0 \\ ( \frac{LG - LB}{Δ} mod 6 ) / 6 & {L}_{max} = LR \\ ( \frac{LB - LR}{Δ} + 2 ) / 6 & {L}_{max} = LG \\ ( \frac{LR - LG}{Δ} + 4 ) / 6 & {L}_{max} = LB\end{matrix} \\ S = \{ \begin{matrix}0 & {L}_{max} = 0 \\ \frac{Δ}{{L}_{max}} & {L}_{max} \neq 0\end{matrix} \\ V = {L}_{max} \\ Δ = {L}_{max} - {L}_{min} \\ {L}_{max} = max ( LR , LG , LB ) \\ {L}_{min} = min ( LR , LG , LB )$$

where H is hue of the color in the HSV color space, S is saturation of the color in the HSV color space, V is value of the color in the HSV color space, LR is a red component of the optical signal, LG is a green component of the optical signal, and LB is a blue component of the optical signal.

Thus, a red component LR_{2020idx_2020idx}(x,y), a green component LG_{2020idx_2020idx}(x,y), and a blue component LB_{2020idx_2020idx}(x,y) of each optical signal L_{2020idx_2020idx}(x,y) in the first optical signal set may be substituted into the above equation as LR, LG, and LB, respectively, so as to obtain a color HVS_{2020idx_2020idx}(x,y) in the HSV color space corresponding to each optical signal L_{2020idx_2020idx}(x,y) in the first optical signal set, thereby obtaining the fourth color set.

Let: the transferring relationship between the optical signal and the color in the HSV color space be RBG2HSV, then:

$${HVS}_{2020 idx \_ 2020 idx} ( x , y ) =$$

$$[ \begin{matrix}{H}_{2020 idx \_ 2020 idx} ( x , y ) \\ {V}_{2020 idx \_ 2020 idx} ( x , y ) \\ {S}_{2020 idx \_ 2020 idx} ( x , y )\end{matrix} ] = RBG 2 HSV ( {L}_{2020 idx \_ 2020 idx} ( x , y ) ) .$$

S306. Transferring the optical signals in the second optical signal set into colors in the HSV color space to obtain the fifth color set.

The second optical signal set is the optical signal set generated in the above Step S302, and the optical signal in the second optical signal set is denoted as L_{2020idx_709idx}(x,y).

Specifically, the implementation of transferring the optical signals in the second optical signal set into the colors in the HSV color space in Step S306 is similar to the implementation of transferring the optical signals in the first optical signal set into the colors in the HSV color space in Step S305 above, which will not be repeated herein.

Let: the transferring relationship between the optical signal and the color in HSV color space be RBG2HSV, then

$${HVS}_{2020 idx \_ 709 idx} ( x , y ) =$$

$$[ \begin{matrix}{H}_{2020 idx \_ 709 idx} ( x , y ) \\ {V}_{2020 idx \_ 709 idx} ( x , y ) \\ {S}_{2020 idx \_ 709 idx} ( x , y )\end{matrix} ] = RBG 2 HSV ( {L}_{2020 idx \_ 709 idx} ( x , y ) ) .$$

S307. Transferring the colors in the second color set into optical signals on the basis of an electro-optical transfer function of the second color display standard to obtain a third optical signal set.

According to the above example, the second color display standard is the SDR color display standard, and an opto-electrical transfer function of the SDR color display standard is:

$$V = \frac{1}{a} [ {max ( {L}_{c} , 0 )}^{\frac{1}{γ}} ] - b \\ a = {( {L}_{ω}^{\frac{1}{γ}} - {L}_{b}^{\frac{1}{γ}} )}^{γ} \\ b = \frac{{L}_{b}^{\frac{1}{γ}}}{{L}_{ω}^{\frac{1}{γ}} - {L}_{b}^{\frac{1}{γ}}}$$

By solving the inverse function of the opto-electrical transfer function of the SDR color display standard, the electro-optical transfer function of the SDR color display standard may be obtained as:

$${L}_{c} = a {\{ max [ ( V + b ) , 0 ] \}}^{γ} \\ a = {( {L}_{ω}^{\frac{1}{γ}} - {L}_{b}^{\frac{1}{γ}} )}^{γ} \\ b = \frac{{L}_{b}^{\frac{1}{γ}}}{{L}_{ω}^{\frac{1}{γ}} - {L}_{b}^{\frac{1}{γ}}}$$

By substituting a red component R_{2020idx_709color}(x,y), a green component R_{2020idx_709color}(x,y), and a blue component R_{2020idx_709color}(x,y) of each color C_{2020idx_709color}(x,y) in the third color set as an electrical signal V into the above-mentioned electro-optical transfer function, each color in the third color set may be transferred into an optical signal L_{2020idx_709color}(x,y), so as to obtain the third optical signal set.

Let: the transferring relationship between the optical signal and the color in HSV color space be RBG2HSV, then

$${HVS}_{2020 {idx}_{709 color}} ( x , y ) =$$

$$[ \begin{matrix}{H}_{2020 {idx}_{709 color}} ( x , y ) \\ {V}_{2020 {idx}_{709 color}} ( x , y ) \\ {S}_{{S}_{2020 {idx}_{709 color}}} ( x , y )\end{matrix} ] = RBG 2 HSV ( {L}_{2020 idx \_ 709 color} ( x , y ) ) .$$

S308. Transferring the optical signals in the third optical signal set into colors HSV_{2020idx_709color}(x,y) in the HSV color space to obtain the sixth color set.

Specifically, the implementation of transferring the optical signals in the third optical signal set into the colors in the HSV color space in Step S308 is similar to the implementation of transferring the optical signals in the first optical signal set into the colors in the HSV color space in Step S305 above, which will not be repeated herein.

By the above Steps S305 to S308, the process of transferring colors in the first color set, the second color set, and the third color set to colors in an HSV color space to obtain a fourth color set, a fifth color set, and a sixth color set corresponding thereto respectively is implemented in the embodiments of the present disclosure.

S309. Obtain the amount of change in hue of each color on the basis of hue of each color in the fifth color set and hue of a corresponding color in the sixth color set.

As an optional implementation of the embodiments of the present disclosure, the amount of change in hue of each color includes a hue difference between each color in the fifth color set and the corresponding color in the sixth color set.

Specifically, the size of the hue of a color is determined by an included angle between the location of the hue of the color in a model of the HVS color space and the standard cross-section of the model. Ideally, if a color in the color mapping card has a change in hue when the color is mapped, the change is reflected in the model of the HVS color space as a change in the included angle between the location of the hue and the standard cross-section of the model. Regardless of the color mapping in any color space, after the color is transferred to the HVS color space, the change in hue is always the change in the included angle between the location of the hue and the standard cross-section, and the change in different color spaces should be consistent. The hue difference between each color in the fifth color set and the corresponding color in the sixth color set may exactly reflect the change in the included angle between the location of the hue and the standard cross-section of an input color and an output color of the original card. Thus, the hue difference between each color of the fifth color set and the corresponding color of the sixth color set may be taken as the amount of change in hue of that color.

That is, ΔH=H_{2020idx_709color}(x,y)−H_{2020idx_709idx}(x,y),
where ΔH is the amount of change in hue of the color, H_{2020idx_709color}(x,y) is hue of the color in the fifth color set, and H_{2020idx_709idx}(x,y) is hue of the color in the sixth color set.

S310. Obtain the amount of change in saturation of each color on the basis of saturation of each color in the fifth color set and saturation of a corresponding color in the sixth color set.

As an optional implementation of the embodiments of the present disclosure, the amount of change in saturation of each color includes a saturation ratio of each color in the fifth color set to the corresponding color in the sixth color set.

Ideally, hues of different color display standards should be aligned, but the lines connecting the three primary colors (color primaries) and the origin under different color display standards do not overlap, so the absolute values of the hues of different color display standards may be different, which leads to inconsistent uniformity of saturation. Due to the inconsistent uniformity of saturation, during determining the amount of change in saturation, the saturation of different color spaces can be normalized and approximated using ratios, so that the amount of change in saturation of each color includes a saturation ratio of each color in the fifth color set to the corresponding color in the sixth color set.

That is, ΔS=S_{2020idx_709color}(x,y)/S_{2020idx_709idx}(x,y),
where ΔS is the amount of change in saturation of the color in the fifth color set, S_{2020idx_709color}(x,y) is saturation of the color in the fifth color set, and S_{2020idx_709idx}(x,y) is saturation of the color in the sixth color set.

S311. Obtain the amount of change in value of each color on the basis of value of each color in the fifth color set and value of a corresponding color in the sixth color set.

As an optional implementation of the embodiments of the present disclosure, the amount of change in value of each color includes a value ratio of each color in the fifth color set to the corresponding color in the sixth color set.

Value ranges of different color display standards may be different significantly. For example, the PQ color display standard has a value range of [0, 10,000] nit, whereas the SDR color display standard has a value range of only [0, 100] nit, and thus when determining the amount of change in saturation, values of the different color display standards may likewise be normalized and approximated using ratios. Accordingly, the amount of change in value of each color includes a value ratio of each color in the fifth color set to the corresponding color in the sixth color set.

That is, ΔV=V_{2020idx_709color}(x,y)/V_{2020idx_709idx}(x,y),
where ΔV is the amount of change in value of the color, V_{2020idx_709color}(x,y) is value of the color in the fifth color set, and V_{2020idx_709idx}(x,y) is value of the color in the sixth color set.

By the above steps S309 to S311, in the embodiments of the present disclosure, the amount of change of each color is obtained on the basis of each color in the fifth color set and the corresponding color in the sixth color set.

S312. Map the hue of each color in the fourth color set by a corresponding hue difference to obtain hue of each color in the seventh color set.

Optionally, the hue of each color in the seventh color set may be obtained by the following formula:

$${H}_{2020 idx \_ 2020 color} ( x , y ) = {H}_{2020 idx \_ 2020 idx} ( x , y ) + Δ H \\ where Δ H = {H}_{2020 idx \_ 709 color} ( x , y ) - {H}_{2020 idx \_ 709 idx} ( x , y ) ,$$

H_{2020idx_709color}(x,y) is hue of the color in the fifth color set, H_{2020idx_709idx}(x,y) is hue of the color in the sixth color set, H_{2020idx_2020idx}(x,y) is hue of the color in the fourth color set, and H_{2020idx_2020color}(x,y) is hue of the color in the seventh color set.

S313. Map the saturation of each color in the fourth color set by a corresponding saturation ratio to obtain saturation of each color in the seventh color set.

Optionally, the saturation of each color in the seventh color set may be obtained by the following formula:

$${S}_{2020 idx \_ 2020 color} ( x , y ) = {S}_{2020 idx \_ 709 color} ( x , y ) \times Δ S \\ where , Δ S = {S}_{2020 idx \_ 709 color} ( x , y ) / {S}_{2020 idx \_ 709 idx} ( x , y ) ,$$

S_{2020idx_709color}(x,y) is saturation of the color in the fifth color set, S_{2020idx_709idx}(x,y) is saturation of the color in the sixth color set, S_{2020idx_709color}(x,y) is saturation of the color in the fourth color set, and S_{2020idx_2020color}(x,y) is saturation of the color in the seventh color set.

S314. Map the value of each color in the fourth color set by a corresponding value ratio to obtain value of each color in the seventh color set.

Optionally, the value of each color in the seventh color set may be obtained by the following formula:

$${V}_{2020 idx \_ 2020 color} ( x , y ) = {V}_{2020 idx \_ 709 color} ( x , y ) \times Δ V \\ where Δ V = {V}_{2020 idx \_ 709 color} ( x , y ) / {V}_{2020 idx \_ 709 idx} ( x , y ) ,$$

V_{2020idx_709color}(x,y) is value of the color in the fifth color set, V_{2020idx_709idx}(x,y) is value of the color in the sixth color set, V_{2020idx_709color}(x,y) is value of the color in the fourth color set, and V_{2020idx_2020color}(x,y) is value of the color in the seventh color set.

By the above Steps S312 to S314, in the embodiments of the present disclosure, the seventh color set is obtained by performing color mapping on the colors in the fourth color set on the basis of the amount of change of each color.

S315. Transferring colors in the seventh color set into optical signals to obtain a fourth optical signal set.

As mentioned above, colors in the seventh color set are colors in the HSV color space, so the transferring relationship between the colors in the seventh color set and the optical signal follows the equation below:

$${L}_{2020 idx \_ 2020 color} ( x , y ) = ( LR , LG , LB ) = \{ \begin{matrix}( C + m , X + m , m ) & 0 \leq H < 1 / 6 \\ ( X + m , C + m , m ) & 1 / 6 \leq H < 1 / 3 \\ ( m , C + m , X + m ) & 1 / 3 \leq H < 1 / 2 \\ ( m , X + m , C + m ) & 1 / 2 \leq H < 2 / 3 \\ ( X + m , m , C + m ) & 2 / 3 \leq H < 5 / 6 \\ ( C + m , m , X + m ) & 5 / 6 \leq H \leq 1\end{matrix} \\ C = {V}_{2020 idx \_ 2020 color} ( x , y ) \times {S}_{2020 idx \_ 2020 color} ( x , y ) \\ X = C \times ( 1 - \vert {H}_{2020 idx \_ 2020 color} ( x , y ) / 6 mod 2 - 1 \vert ) \\ m = {V}_{2020 idx \_ 2020 color} ( x , y ) - C ;$$

where LR is a red component of the optical signal in the fourth optical signal set, LG is a green component of the optical signal in the fourth optical signal set, LG is a blue component of the optical signal in the fourth optical signal set, H_{2020idx_2020color}(x,y) is hue of the color in the seventh color set, S_{2020idx_2020color}(x,y) is saturation of the color in the seventh color set, and V_{2020idx_2020color}(x,y) is value of the color in the seventh color set.

S316. Transferring optical signals in the fourth optical signal set into colors in the first color space on the basis of an electro-optical transfer function of the first color display standard.

As mentioned above, the first color display standard is the PQ color display standard, and the first color space is bt.2020, so the transferring relationship between the optical signals in the fourth optical signal set and the colors in the first color space follows the equation below:

$$V = {( \frac{{c}_{1} + {c}_{2} {L}_{c}^{{m}_{1}} / 10000}{1 + {c}_{3} {L}_{c}^{{m}_{1}} / 10000} )}^{{m}_{2}} \\ \{ \begin{matrix}{m}_{1} = 0.1593017578125 \\ {m}_{2} = 78.84375 \\ {c}_{2} = 18.8515625 \\ {c}_{3} = 18.6875 \\ {c}_{1} = {c}_{3} - {c}_{2} + 1.\end{matrix}$$

By substituting a red component LR, a green component LG, and a green component LB of an optical signal L_{2020idx_2020color}(x,y) in the fourth optical signal set into the above equation as L_{c} respectively, to obtain a red component R_{2020idx_2020color}(x,y), a green component G_{2020idx_2020color}(x,y), and a blue component B_{2020idx_2020color}(x,y) of each color in the eighth color set, so as to obtain the eighth color set.

By the above Steps S312 to S314, in the embodiments of the present disclosure, the eighth color set is obtained by transferring the colors in the seventh color set to the colors in the first color space.

S317. Generate a color mapping card under the first color display standard on the basis of each color in the eighth color set and a corresponding relationship between each color in the eighth color set and each color in the first color set.

As an optional implementation of the embodiments of the present disclosure, the implementation of the above Step S317 (generate a color mapping card under the first color display standard on the basis of each color in the eighth color set and a corresponding relationship between each color in the eighth color set and each color in the first color set) may include Step I to Step V as below.

Step I. Generate a standard color card for the first color space.

That is, a color card that can map each color in the first color space by the corresponding coordinate value is generated.

Illustratively, the implementation of the above Step I (generate a standard color card of the first color space) is illustrated below using the first color display standard being the PQ color display standard as an example.

Since the color space of the PQ color display standard is bt.2020, and a color in the color space bt.2020 includes: a red component, a green component, and a blue component, the total number of colors in the first color space is: T_{R}*T_{G}*T_{B}, where T_{R}, T_{G}, and T_{B} are the total number of red components, the total number of green components, and the total number of blue components, respectively, and the standard color card of the first color space may include T_{R}*T_{G}*T_{B} color patches, each color patch has a unique coordinate value on the standard color card, and the coordinate value of each color patch may uniquely map a color in the first color space. In addition, when the standard color card of the first color space contains T_{R}*T_{G}*T_{B} color patches, the arrangement of the T_{R}*T_{G}*T_{B} color patches in the standard color card of the first color space may be as follows: color patches having the same blue components are put to a color patch group, and accordingly a total of T_{B} color patch groups may be obtained, each of which includes T_{R}*T_{G} color patches. The blue components of T_{B} color patch groups are increased from 0 to T_{B}−1 one by one from left to right and from top to bottom, so as to form a square matrix of \sqrt{T_{B}}*\sqrt{T_{B}} consisting of color patch groups. Color patches having the same red components are set in the same row and color patches having the same green components are set in the same column in each color patch group. The red components are increased from 0 to T_{R}−1 one by one, from left to right, and the green components are increased from 0 to T_{G}−1 one by one, from left to right, thereby forming a color card with the number of rows being T_{R}*\sqrt{T_{B}} and the number of columns being T_{G}*\sqrt{T_{B}}.

Further, in order to reduce the amount of computation of the method for generating a color mapping card, the red component, the green component, and the blue component of the first color space may be sampled with a preset value as a sampling step, and only the color patches corresponding to the sampling values of the red component, the green component, and the blue component are generated, thereby obtaining a standard color card containing SP_{R}*SP_{G}*SP_{B} color patches, where SP_{R}, SP_{G} and SP_{B} are the number of sampling values for the red component, the number of sampling values for the green component, and the number of sampling values of the blue component, respectively. For example, if T_{R}, T_{G}, and T_{B} are all 256, then the red component, the green component, and the blue component may be sampled in a sampling step size of 4 to obtain a sampling value SP_{R}=64 of the red component, where R=0, R=1/63*255, R=2/63*255, R=3/63*255, . . . , R=62/63*255, and R=1, a sampling value SP_{G}=64 of the green component, where G=0, G=1/63*255, G=2/63*255, G=3/63*255, . . . , G=62/63*255, and G=1, and a sampling value SP_{B}=64 of the blue component, where B=0, B=1/63*255, B=2/63*255, B=3/63*255, . . . , B=62/63*255, and B=1, so as to obtain a standard color card containing 64*64*64 color patches. In addition, when the standard color card of the first color space contains SP_{R}*SP_{G}*SP_{B} color patches, the SP_{R}*SP_{G}*SP_{B} color patches are arranged in the standard color card in such a way that color patches having the same blue components are put into a color patch group, and accordingly a total of SP_{B} color patch groups can be obtained, each of which includes SP_{R}*SP_{G} color patches. The blue components of the SP_{B} color patch groups are increased one by one from left to right, from top to bottom, from the minimum sampling value to the maximum sampling value, so as to form a square matrix of \sqrt{SP_{B}}*\sqrt{SP_{B}} consisting of color patch groups. In each color patch group, color patches having the same red components are set in the same row, and color patches having the same green components are set in the same column. The red components are increased one by one from the minimum sampling value to the maximum sampling value from the left to the right, and the green components are increased one by one from the minimum to the maximum sampling value from the left to the right, so that the standard color card with the number of rows being SP_{R}*\sqrt{SP_{B}} and the number of columns being SP_{G}*\sqrt{SP_{B}} is formed.

Further, before the above Step I (generate a standard color card of the first color space), the method for generating a color mapping card according to the embodiments the present disclosure further includes:
normalizing color components of each color in the first color set.

That is, a color minimum

$${C}_{min} = [ \begin{matrix}R \\ G \\ B\end{matrix} ] = [ \begin{matrix}0 \\ 0 \\ 0\end{matrix} ]$$

in the first color space and a color maximum

$${C}_{max} = [ \begin{matrix}R \\ G \\ B\end{matrix} ] = [ \begin{matrix}1 \\ 1 \\ 1\end{matrix} ]$$

in the first color space are defined, and other colors are in the form of floating points between the color minimum Cₘᵢₙ and the color maximum Cₘₐₓ.

Specifically, a color in a first color space may be represented as a color of different precision using multiple color ranges. For example, a color component may be represented by 8 bits so that the first color space contains 256*256*256 colors, or a color component may be represented by 10 bits so that the first color space contains 1024*1024*1024 colors. In the above embodiments, the color components of each color in the first color set are normalized before the standard color card of the first color space is generated, thus the accuracy of the colors may be simplified and the amount of computation is reduced.

Step II. Establish a mapping relationship between each color in the first color set and a coordinate value in the standard color card.

Illustratively, when the first color display standard is the PQ color display standard, the standard color card includes 512*512 color patches, and the color patches with the same blue components in the standard color card form a color patch group, the blue components of the color patch group are gradually increased from 0 to 1 one by one from the left to the right and from the top to the bottom, the color patches with the same red components in the various color patch groups are located in the same row, the color patches with the same green components are located in the same row, the red components are increased one by one from 0 to 1 from the left to the right, and the green components are increased one by one from 0 to 1 from the left to the right, the mapping relationship of the various colors in the first color display standard to the coordinate values in the standard color card is shown below:

$${C}_{( x , y ) =} [ \begin{matrix}{R}_{( x , y )} \\ {G}_{( x , y )} \\ {B}_{( x , y )}\end{matrix} ] = [ \begin{matrix}\frac{x mod 64}{63} \times {R}_{max} \\ \frac{y mod 64}{63} \times {G}_{max} \\ \frac{⌊ \frac{y}{64} ⌋ \times 8 + ⌊ \frac{x}{64} ⌋}{63} \times {B}_{max}\end{matrix} ]$$

where x is a horizontal coordinate value in the standard color card, y is a vertical coordinate value in the standard color card, mod is a residual function, └n┘ is a round down function, and Rₘₐₓ, Gₘₐₓ, Bₘₐₓ are maximum values of the red component, the green component and the blue component in the PQ color display standard, respectively.

Step III. Obtain a coordinate value corresponding to each color in the eighth color set on the basis of the mapping relationship between each color in the first color set and the coordinate value in the standard color card and a corresponding relationship between each color in the eighth color set and each color in the first color set.

For example, the corresponding relationship between each color in the first color set and a coordinate value in the standard color card includes: a coordinate value (x₁,y₁) in the standard color card corresponds to a color C_{2020idx}_{_{2020idx}}(x₁,y₁) in the first color space, and the corresponding relationship between each color in the eighth color set and each color in the first color set includes: a color C_{2020idx}_{_{2020idx}}(x₁,y₁) in the first color space corresponds to a color C_{2020idx_2020color}(x₁,y₁) in the eighth color set, and a coordinate value corresponding to the color C_{2020idx_2020color}(x₁,y₁) in the eighth color set is (x₁,y₁).

Step V. Generate a color mapping card under the first color display standard on the basis of the colors in the eighth color set and coordinate values corresponding to the colors in the eighth color set.

Specifically, a color patch of each color in the eighth color set may be set at a coordinate value corresponding to each color in the eighth color set, so as to generate the color mapping card under the first color display standard.

The method for generating a color mapping card according to the embodiments of the present disclosure includes: transferring colors in a first color space of a first color display standard to colors in a second color space of a second color display standard, mapping colors in the transferred second color set by a color mapping card under a second color display standard to obtain a third color set, transferring colors in the first color space, the second color set, and the third color set to colors in an HSV color space to obtain a fourth color set, a fifth color set, and a sixth color set corresponding thereto respectively,; further, obtaining the amount of change of each color on the basis of each color in the fifth color set and a corresponding color in the sixth color set; performing color mapping on the colors in the fourth color set on the basis of the amount of change of each color to obtain a seventh color set; transferring colors in the seventh color set to colors in the first color space to obtain an eighth color set; and generating a color mapping card under the first color display standard on the basis of each color in the eighth color set and a corresponding relationship between each color in the eighth color set and each color in the first color set.

That is, the embodiments of the present disclosure provide a method for generating a color mapping card, in which the amount of change in an input color and an output color of original map colors can be extracted, colors in the first color space can be mapped on the basis of the amount of change of the input color and the output color of the original map colors, and finally the color mapping card under the first color display standard is generated. Therefore, the embodiments of the present disclosure provide an implementation of generating the color mapping card under the first color display standard by the color mapping card under the second color display standard, solving the problem of how to generate a color mapping card under other color display standard by a color mapping card under one color display standard.

Based on the similalr inventive conception, as an implementation of the foregoing methods, embodiments of the present disclosure further provide an apparatus for generating a color mapping card. The apparatus embodiments correspond to the foregoing method embodiments. For ease of reading, the apparatus embodiment will not repeat the details of the foregoing method embodiments one by one. However, it should be clear that the apparatus for generating a color mapping card in the embodiments can correspondingly implement all the contents in the foregoing method embodiments.

The embodiments of the present disclosure provide an apparatus for generating a color mapping card according to embodiments of the present disclosure. FIG. 5 is a schematic structural diagram of an apparatus for generating a color mapping card. As shown in FIG. 5, the apparatus 500 for generating a color mapping card includes:
a first transferring unit 51, configured to transfer colors in a first color set to colors in a second color space of a second color display standard to obtain a second color set; the first color set including colors in a first color space of a first color display standard;
a mapping unit 52, configured to map colors in the second color set by original color mapping card to obtain a third color set; the original color mapping card being color mapping card under the second color display standard;
a second transferring unit 53, configured to transfer the colors in the first color set, the second color set, and the third color set to colors in an HSV color space to obtain a fourth color set, a fifth color set, and a sixth color set corresponding thereto respectively; and
a generation unit 54, configured to perform color mapping on colors in the fourth color set on the basis of colors in the fifth color set and corresponding colors in the sixth color set to generate a color mapping card under the first color display standard.

As an optional implementation of the embodiments of the present disclosure, the generation unit 54 may be configured to obtain the amount of change of each color on the basis of each color in the fifth color set and a corresponding color in the sixth color set; perform color mapping on the colors in the fourth color set on the basis of the amount of change of each color to obtain a seventh color set; transfer colors in the seventh color set to colors in the first color space to obtain an eighth color set; and generate a color mapping card under the first color display standard on the basis of each color in the eighth color set and a corresponding relationship between each color in the eighth color set and each color in the first color set.

As an optional implementation of the embodiments of the present disclosure, the first transferring unit 51 may be configured to transfer the colors in the first color set into optical signals on the basis of an electro-optical transfer function of the first color display standard to obtain a first optical signal set; transfer optical signals in the first optical signal set to optical signals under the second color display standard to obtain a second optical signal set; and transfer optical signals in the second optical signal set into colors in the second color space on the basis of an opto-electrical transfer function of the second color display standard to obtain the second color set.

As an optional implementation of the embodiments of the present disclosure, the second transferring unit 53 may be configured to transfer the colors in the first color set to optical signals on the basis of an electro-optical transfer function of the first color display standard to obtain a first optical signal set; and transfer the optical signals in the first optical signal set to colors in the HSV color space to obtain the fourth color set.

As an optional implementation of the embodiments of the present disclosure, the second transferring unit 53 may be configured to transfer the colors in the second color set and the third color set to optical signals on the basis of an electro-optical transfer function of the second color display standard respectively to obtain a second optical signal set and a third optical signal set; and transfer the optical signals in the second optical signal set and the third optical signal set to colors in the HSV color space respectively to obtain the fifth color set and the sixth color set.

As an optional implementation of the embodiments of the present disclosure, the generation unit 54 may be configured to obtain the amount of change in hue of each color on the basis of hue of each color in the fifth color set and hue of a corresponding color in the sixth color set; obtain the amount of change in saturation of each color on the basis of saturation of each color in the fifth color set and saturation of a corresponding color in the sixth color set; and obtain the amount of change in value of each color on the basis of value of each color in the fifth color set and value of a corresponding color in the sixth color set.

As an optional implementation of the embodiments of the present disclosure,
the amount of change in hue of each color includes a hue difference between each color in the fifth color set and a corresponding color in the sixth color set;
the amount of change in saturation of each color includes a saturation ratio of each color in the fifth color set to a corresponding color in the sixth color set; and
the amount of change in value of each color includes a value ratio of each color in the fifth color set to a corresponding color in the sixth color set.

As an optional implementation of the embodiments of the present disclosure, the generation unit 54 may be configured to map hue of each color in the fourth color set to the sum of the hue of each color in the fourth color set and the corresponding amount of change in hue; map saturation of each color in the fourth color set to the product of the saturation of each color in the fourth color set and the corresponding amount of change in saturation; and map value of each color in the fourth color set to the product of the value of each color in the fourth color set and the corresponding amount of change in value.

As an optional implementation of the embodiments of the present disclosure, the generation unit 54 may be configured to transfer colors in the seventh color set into optical signals to obtain a fourth optical signal set; and transfer optical signals in the fourth optical signal set into colors in the first color space on the basis of an opto-electrical transfer function of the first color display standard to obtain the eighth color set.

As an optional implementation of the embodiments of the present disclosure, the generation unit 54 may be configured to generate a standard color card for the first color space; establishing a mapping relationship between each color in the first color set and a coordinate value in the standard color card; obtain a coordinate value corresponding to each color in the eighth color set on the basis of the mapping relationship between each color in the first color set and the coordinate value in the standard color card and a corresponding relationship between each color in the eighth color set and each color in the first color set; and generate a color mapping card under the first color display standard on the basis of the colors in the eighth color set and coordinate values corresponding to the colors in the eighth color set.

As an optional implementation of the embodiments of the present disclosure, the generation unit 54 may be configured to normalize color components of each color in the first color set.

As an optional implementation of the embodiments of the present disclosure, the original color mapping card include a plurality of mapping color groups; first color components of the plurality of mapping color groups being a plurality of sampling values of first color components of the second space, respectively;
the mapping unit 52 may be configured to obtain a first mapping color group and a second mapping color group corresponding to each color on the basis of a first color component of each color in the second color set; the first mapping color group and the second mapping color group corresponding to any color being mapping color groups with first color components adjacent to the first color component of that color; obtain a first coordinate value and a second coordinate value corresponding to each color in the first mapping color group and the second mapping color group, respectively on the basis of a second color component and a third color component of each color in the second color set; read a first map color and a second map color of each color in the original color mapping card on the basis of the first coordinate value and the second coordinate value corresponding to each color in the second color set, respectively; obtain a map color of each color in the second color set on the basis of the first map color and the second map color of each color in the second color set; and generate the third color set on the basis of the map color of each color in the second color set.

As an optional implementation of the embodiments of the present disclosure, the mapping unit 52 may be configured to obtain a weighting coefficient for each color in the second color set on the basis of the first color component of each color in the second color set; and weight the first map color and the second map color of each color in the first color set on the basis of the weighting coefficient to obtain a map color of each color in the second color set.

As an optional implementation of the embodiments of the present disclosure,
the first color display standard is a high dynamic range HDR color display standard; and
the second color display standard is a standard dynamic range SDR color display standard.

The apparatus for generating a color mapping card according to embodiments of the present disclosure may implement the method for generating a color mapping card according to the above embodiments, which has the similar implementation principle and technical effect and will not be repeated herein.

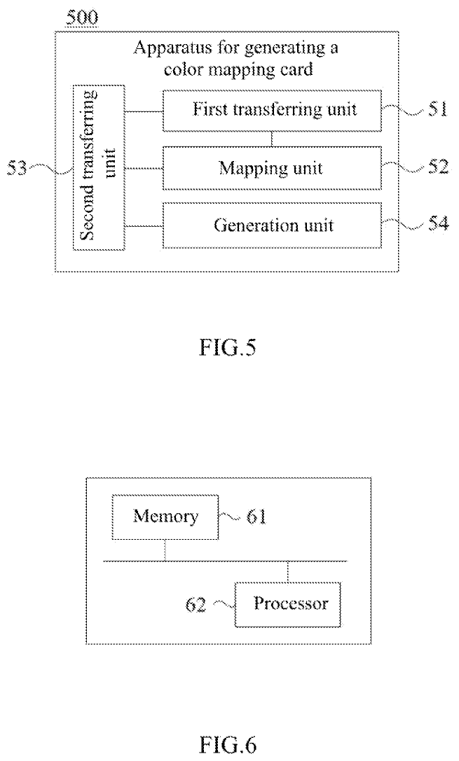

Based on the similar inventive concept, embodiments of the present disclosure further provide an electronic device. FIG. 6 is a schematic structural diagram of an electronic device according to embodiments of the present disclosure. As shown in FIG. 6, the electronic device provided in the embodiments includes a memory 61 and a processor 62, the memory 61 being configured to store a computer program, the processor 62 being configured to, when executing the computer program, cause the electronic device to implement the method for generating a color mapping card of the foregoing embodiments.

Embodiments of the present disclosure further provide a computer-readable storage medium, the computer-readable storage medium storing a computer program which, when executed by a computing device, causing the computing device to implement the method for generating a color mapping card of the foregoing embodiments.

Embodiments of the present disclosure further provides a computer program product, when run on a computer, the computer program product causing the computer to implement the method for generating a color mapping card of the foregoing embodiments.

It should be appreciated by those skilled in the art that the embodiments of the present disclosure may be provided as methods, systems, or computer program products. Accordingly, the embodiments of the present disclosure may employ the form of fully hardware embodiments, fully software embodiments, or embodiments combining software and hardware aspects. Furthermore, the embodiments of the present disclosure can be in the form of a computer program product implemented on one or more computer-usable storage media including computer usable program code.

The processor may be a central processing unit (Central Processing Unit, CPU), or another general-purpose processor, a digital signal processor (Digital Signal Processor, DSP), a special-purpose integrated circuit (Application Specific Integrated Circuit, ASIC), a field-programmable gate array (Field-Programmable Gate Array, FPGA) or other programmable logic devices, discrete logic devices, and other programmable logic device, a discrete gate or transistor logic device, or a discrete hardware components, etc. The general-purpose processor may be a microprocessor, or the processor may also be any conventional processor or the like.

The memory may include a non-permanent memory in a computer readable medium, a random-access memory (RAM) and/or a non-volatile memory in the form of, for example, a read-only memory (ROM) or a flash memory (flash RAM). The memory is an example of the computer-readable medium.

The computer-readable medium includes permanent and non-permanent, removable and non-removable storage media. The storage media may be used by any method or technology to implement information storage. The information may be computer-readable instructions, data structures, program modules, or other data. Examples of the storage media for computers include, but are not limited to, a phase-change memory (PRAM), a static random-access memory (SRAM), a dynamic random-access memory (DRAM), another type of random-access memory (RAM), a read-only memory (ROM), an electrically erasable programmable read-only memory (EEPROM), a flash memory or other memory technology, a read-only CD-ROM, a digital versatile disk (DVD) or other optical storage, a magnetic cartridge tape, disk storage or other magnetic storage devices or any other non-transmission media, which can be used to store information that can be accessed by the computing device. As defined herein, the computer-readable medium does not include computer-readable transitory media, such as a modulated data signal and a carrier.

Finally, it should be noted that the above embodiments are only used to illustrate the technical solutions of the disclosed embodiments, and not to limit them. Although the disclosed embodiments have been described in detail with reference to the aforementioned embodiments, ordinary technical personnel in the art should understand that they can still modify the technical solutions recorded in the aforementioned embodiments, or equivalently replace some or all of the technical features. And, these modifications or replacements do not make the essence of the corresponding technical solutions separate from the scope of the technical solutions of the embodiments disclosed in this disclosure.

1. A method for generating a color mapping card, comprising:
transferring colors in a first color set to colors in a second color space of a second color display standard to obtain a second color set, wherein the first color set comprises colors in a first color space of a first color display standard;
mapping colors in the second color set by an original color mapping card to obtain a third color set, wherein the original color mapping card is a color mapping card under the second color display standard;
transferring colors in the first color set, the second color set, and the third color set to colors in an HSV color space to obtain a fourth color set, a fifth color set, and a sixth color set corresponding thereto respectively; and
performing color mapping on colors in the fourth color set on the basis of colors in the fifth color set and corresponding colors in the sixth color set to generate a color mapping card under the first color display standard.

2. The method according to claim 1, wherein performing color mapping on colors in the fourth color set according to colors in the fifth color set and corresponding colors in the sixth color set to generate a color mapping card under the first color display standard comprises:
obtaining an amount of change of each color on the basis of each color in the fifth color set and a corresponding color in the sixth color set;
performing color mapping on the colors in the fourth color set on the basis of the amount of change of each color to obtain a seventh color set;
transferring colors in the seventh color set to colors in the first color space to obtain an eighth color set; and
generating a color mapping card under the first color display standard on the basis of colors in the eighth color set and a corresponding relationship between colors in the eighth color set and colors in the first color set.

3. The method according to claim 1, wherein the transferring colors in a first color set to colors in a second color space of a second color display standard to obtain a second color set comprises:
transferring the colors in the first color set into optical signals on the basis of an electro-optical transfer function of the first color display standard to obtain a first optical signal set;
transferring optical signals in the first optical signal set to optical signals under the second color display standard to obtain a second optical signal set; and
transferring optical signals in the second optical signal set into colors in the second color space on the basis of an opto-electrical transfer function of the second color display standard to obtain the second color set.

4. The method according to claim 1, wherein the transferring colors in the first color set, the second color set, and the third color set to colors in an HSV color space to obtain a fourth color set, a fifth color set, and a sixth color set corresponding thereto respectively comprises:
transferring the colors in the first color set into optical signals on the basis of an electro-optical transfer function of the first color display standard to obtain a first optical signal set; and
transferring optical signals in the first optical signal set into colors in the HSV color space to obtain the fourth color set.

5. The method according to claim 1, wherein the transferring colors in the first color set, the second color set, and the third color set to colors in an HSV color space to obtain a fourth color set, a fifth color set, and a sixth color set corresponding thereto respectively comprises:
transferring the colors in the second color set and the third color set into optical signals on the basis of an electro-optical transfer function of the second color display standard respectively to obtain a second optical signal set and a third optical signal set; and
transferring optical signals in the second optical signal set and the third optical signal set into colors in the HSV color space respectively to obtain the fifth color set and the sixth color set.

6. The method according to claim 2, wherein the obtaining the amount of change of each color on the basis of each color in the fifth color set and a corresponding color in the sixth color set comprises:
obtaining an amount of change in hue of each color on the basis of hue of each color in the fifth color set and hue of a corresponding color in the sixth color set;
obtaining an amount of change in saturation of each color on the basis of saturation of each color in the fifth color set and saturation of a corresponding color in the sixth color set; and
obtaining an amount of change in value of each color on the basis of value of each color in the fifth color set and value of a corresponding color in the sixth color set.

7. The method according to claim 6, wherein
the amount of change in hue of each color comprises a hue difference between each color in the fifth color set and the corresponding color in the sixth color set;
the amount of change in saturation of each color comprises a saturation ratio of each color in the fifth color set to the corresponding color in the sixth color set; and
the amount of change in value of each color comprises a value ratio of each color in the fifth color set to the corresponding color in the sixth color set.

8. The method according to claim 7, wherein the performing color mapping on the colors in the fourth color set on the basis of the amount of change of each color to obtain a seventh color set comprises:
mapping hue of each color in the fourth color set by a corresponding hue difference to obtain hue of each color in the seventh color set;
mapping saturation of each color in the fourth color set by the corresponding the saturation ratio to obtain saturation of each color in the seventh color set; and
mapping value of each color in the fourth color set by the corresponding value ratio to obtain value of each color in the seventh color set.

9. The method according to claim 2, wherein the transferring colors in the seventh color set to colors in the first color space to obtain an eighth color set comprises:
transferring colors in the seventh color set into optical signals to obtain a fourth optical signal set; and
transferring optical signals in the fourth optical signal set into colors in the first color space on the basis of an opto-electrical transfer function of the first color display standard to obtain the eighth color set.

10. The method according to claim 2, wherein the generating a color mapping card under the first color display standard on the basis of colors in the eighth color set and a corresponding relationship between colors in the eighth color set and colors in the first color set comprises:
generating a standard color card for the first color space;
obtaining a mapping relationship between each color in the first color set and a coordinate value in the standard color card;
obtaining a coordinate value corresponding to each color in the eighth color set on the basis of the mapping relationship between each color in the first color set and the coordinate value in the standard color card and a corresponding relationship between each color in the eighth color set and each color in the first color set; and
generating the color mapping card under the first color display standard on the basis of each color in the eighth color set and the coordinate value corresponding to each color in the eighth color set.

11. The method according to claim 10, wherein before generating the standard color card of the first color space, the method further comprises:
normalizing color components of each color in the first color set.

12. The method according to claim 1, wherein the original color mapping card comprises a plurality of mapping color groups; first color components of the plurality of mapping color groups are a plurality of sampling values of first color components of the second space, respectively;
the mapping colors in the second color set by an original color mapping card to obtain a third color set comprises:
obtaining a first mapping color group and a second mapping color group corresponding to each color on the basis of a first color component of each color in the second color set, wherein the first mapping color group and the second mapping color group correspond to any color are mapping color groups with first color components adjacent to the first color component of that color;
obtaining a first coordinate value and a second coordinate value corresponding to each color in the first mapping color group and the second mapping color group respectively on the basis of a second color component and a third color component of each color in the second color set;
reading a first map color and a second map color of each color in the original color mapping card on the basis of the first coordinate value and the second coordinate value corresponding to each color in the second color set respectively;
obtaining a map color of each color in the second color set on the basis of the first map color and the second map color of each color in the second color set; and
generating the third color set on the basis of the map color of each color in the second color set.

13. The method according to claim 12, wherein the obtaining a map color of each color in the second color set on the basis of the first map color and the second map color of each color in the second color set comprises:
obtaining a weighting coefficient for each color in the second color set on the basis of the first color component of each color in the second color set; and
weighting the first map color and the second map color of each color in the first color set on the basis of the weighting coefficient to obtain the map color of each color in the second color set.

14. The method according to claim 1, wherein
the first color display standard is a high dynamic range HDR color display standard; and
the second color display standard is a standard dynamic range SDR color display standard.

15. An apparatus for generating a color mapping card, comprising:
a first transferring unit, configured to transfer colors in a first color set to colors in a second color space of a second color display standard to obtain a second color set, wherein the first color set comprises colors in a first color space of a first color display standard;
a mapping unit, configured to map colors in the second color set by an original color mapping card to obtain a third color set, wherein the original color mapping card is a color mapping card under the second color display standard;
a second transferring unit, configured to transfer colors in the first color set, the second color set, and the third color set to colors in an HSV color space to obtain a fourth color set, a fifth color set, and a sixth color set corresponding thereto respectively; and
a generation unit, configured to perform color mapping on colors in the fourth color set on the basis of colors in the fifth color set and corresponding colors in the sixth color set to generate a color mapping card under the first color display standard.

16. An electronic device, comprising a memory and a processor, wherein the memory is configured to store a computer program, the processor is configured to, when executing the computer program, cause the electronic device to implement:
transfer colors in a first color set to colors in a second color space of a second color display standard to obtain a second color set, wherein the first color set comprises colors in a first color space of a first color display standard;
map colors in the second color set by an original color mapping card to obtain a third color set, wherein the original color mapping card is a color mapping card under the second color display standard;
transfer colors in the first color set, the second color set, and the third color set to colors in an HSV color space to obtain a fourth color set, a fifth color set, and a sixth color set corresponding thereto respectively; and
perform color mapping on colors in the fourth color set on the basis of colors in the fifth color set and corresponding colors in the sixth color set to generate a color mapping card under the first color display standard.

17. A computer-readable storage medium, wherein the computer-readable storage medium stores a computer program which, when executed by a computing device, causes the computing device to implement the method for generating a color mapping card of claim 1.

18. A computer program product, wherein the computer program product, when executed on a computer, causes the computer to implement the method for generating a color mapping card of claim 1.

19. The electronic device according to claim 16, wherein the performing color mapping on colors in the fourth color set according to colors in the fifth color set and corresponding colors in the sixth color set to generate a color mapping card under the first color display standard comprises:
obtaining an amount of change of each color on the basis of each color in the fifth color set and a corresponding color in the sixth color set;
performing color mapping on the colors in the fourth color set on the basis of the amount of change of each color to obtain a seventh color set;
transferring colors in the seventh color set to colors in the first color space to obtain an eighth color set; and
generating a color mapping card under the first color display standard on the basis of colors in the eighth color set and a corresponding relationship between colors in the eighth color set and colors in the first color set.

20. The electronic device according to claim 16, wherein
the first color display standard is a high dynamic range HDR color display standard; and
the second color display standard is a standard dynamic range SDR color display standard.
